(19) United States
(12) Patent Application Publication
(10) Pub. No.: US 2012/0311327 A1
(43) Pub. Date: Dec. 6, 2012

(54) DATA CRYPTO METHOD FOR DATA DE-DUPLICATION AND SYSTEM THEREOF

(75) Inventors: Wei Liu, Tianjin (CN); Chih-Feng Chen, Taipei (TW)

(73) Assignee: INVENTEC CORPORATION, Taipei (TW)

(21) Appl. No.: 13/269,679

(22) Filed: Oct. 10, 2011

(30) Foreign Application Priority Data
Jun. 2, 2011 (CN) 201110158165.8

(51) Int. Cl. G06F 21/24

(52) U.S. Cl. 713/167

(57) ABSTRACT

A data crypto method for data de-duplication and a system thereof are described. The data crypto method includes the following steps. A client performs a data de-duplication procedure and generates a partitioned data block. Each client has a respective first key. The partitioned data block is enciphered by using the first key, and corresponding ciphertext data is generated. The ciphertext data is transported to a server. The server searches an crypto look-up table for the corresponding first key and restores the partitioned data block from the ciphertext data through the first key. The server generates stored data from the restored partitioned data block by using a second key. The server restores the partitioned data block from the stored data through the second key and enciphers the partitioned data block to be the ciphertext data according to the corresponding first key. The server transports the ciphertext data to the corresponding client.

### CROSS-REFERENCE TO RELATED APPLICATIONS

This non-provisional application claims priority under 35 U.S.C. §119(a) on Patent Application No(s). 201110158165.8 filed in China, P.R.C. on Jun. 2, 2011, the entire contents of which are hereby incorporated by reference.

### BACKGROUND OF THE INVENTION

1. Field of the Invention

The present invention relates to a data crypto method and a system thereof, and more particularly to a data crypto method for data de-duplication and a system thereof.

2. Related Art

Data de-duplication is a data reduction technology and generally used for a disk-based backup system for the main purpose of reducing storage capacity used in a storage system. A working mode of the data de-duplication is searching for duplicated data blocks of viable sizes at different locations in different files within a certain period of time. The duplicated data blocks may be replaced with an indicator. A large quantity of redundant data always exists in the storage system. In order to solve the problem to conserve more space, the de-duplication technology logically becomes a focus point of people. The de-duplication technology can be adopted to reduce stored data to 1/20 of the original stored data, so as to obtain more backup space, so that not only can backup data in the storage system be saved for a longer time, but also a large amount of bandwidth required in the process of off-line storing can be conserved.

In the process of data de-duplication, a client performs a partitioning process on an input file. After the input file is partitioned, a plurality of data blocks is generated. Then, the client performs a hash process on the data blocks, and a hash value of each data block is generated accordingly. The client compares the obtained hash value with a hash value stored in a server and determines whether the obtained hash value is the same as the hash value stored in the server. If the obtained hash value is the same as the hash value stored in the server, it indicates that the data block having the same hash value was stored in the server.

Generally, a plurality of clients exists in the same Local Area Network (LAN) (or Internet). FIG. 1A is a schematic diagram of data transmission of the prior art. Referring to FIG. 1A, when data transaction occurs on each client, the client performs a data block backup process on a server 121. If data is directly transmitted in a public network, confidences may be leaked out. Therefore, a client A111 and a client B112 perform an crypto process on the data before transmitting the data, as shown in FIG. 1B. In FIG. 1B, the same key is shared among all clients. For example, plaintext data of the client A111 is “12345”. After the client A111 enciphers the plaintext data, ciphertext data “23456” is generated. Then, the client A111 transports the ciphertext data “23456” to the server 121. At the same time, if the client B112 enciphers the plaintext “12345”, the same ciphertext “23456” is also generated. Although for the conventional technology, implementation is rapid and management is convenient, once the key is obtained by another person, the overall security is gone.

In order to eliminate the disadvantage, totally different keys are assigned for the clients respectively. When the client intends to transmit data to the server 121, the client may encipher the data through a held key, referring to FIG. 1C. The keys of the clients are different, so different ciphertexts are generated for plaintext data having the same contents. In other words, after the plaintext data having the same contents is enciphered, different pieces of ciphertext contents are generated, so that the server 121 needs to store different ciphertexts individually, although the plaintexts are totally the same. Therefore, the server 121 cannot achieve the purposes of data de-duplication and storage.

### SUMMARY OF THE INVENTION

In view of the above problems, the present invention is a data crypto method for data de-duplication, for determining whether enciphered partitioned data blocks generated by clients are the same, so that a server can achieve purposes of secrecy and data de-duplication at the same time.

The present invention provides a data crypto method for data de-duplication, which comprises the following steps. A client performs a data de-duplication procedure and generates a partitioned data block. The client performs a first crypto/decipherment procedure on the partitioned data block to generate corresponding ciphertext data, and transports the ciphertext data to a server. The server searches an crypto look-up table for the corresponding first crypto/decipherment procedure according to the client and restores the partitioned data block from the ciphertext data through the first crypto/decipherment procedure. The server performs a second crypto/decipherment procedure on the restored partitioned data block to generate stored data and records the stored data in the server.

When the client intends to obtain data from the server, the client sends a data demanding request to the server. The server restores the partitioned data block from the stored data according to the second crypto/decipherment procedure. The server enciphers the partitioned data block to be the ciphertext data according to the client and the corresponding first crypto/decipherment procedure and then transports the ciphertext data to the corresponding client.

The present invention further provides a data crypto system for data de-duplication, which comprises a plurality of clients and a server. Each client performs a first crypto/decipherment procedure on a partitioned data block to generate corresponding ciphertext data. The server stores an crypto look-up table and a second crypto/decipherment procedure, in which the crypto look-up table is used to record the first crypto/decipherment procedure of each client. The server receives the ciphertext data transported by the client. The server searches the crypto look-up table for the corresponding first crypto/decipherment procedure according to the client and restores the partitioned data block from the ciphertext data through the first crypto/decipherment procedure. The server performs the second crypto/decipherment procedure on the restored partitioned data block to generate stored data.

Through the data crypto method for the data de-duplication and the system thereof according to the present invention, each client can perform an crypto process on the partitioned data block in a respective crypto manner. Therefore, according to the present invention, the enciphered ciphertext data can be transported to the server in a public network environment. When the client intends to restore the data, the client can send the data demanding request to the server. The server deciphers the stored data and performs the corresponding crypto process according to the different clients. Therefore, the purpose of secure communication of transmission between the server and the client can be achieved.

### BRIEF DESCRIPTION OF THE DRAWINGS

The present invention will become more fully understood from the detailed description given herein below for illustration only, and thus are not limitative of the present invention, and wherein:

FIG. 1A is a schematic diagram of data transmission of the prior art;

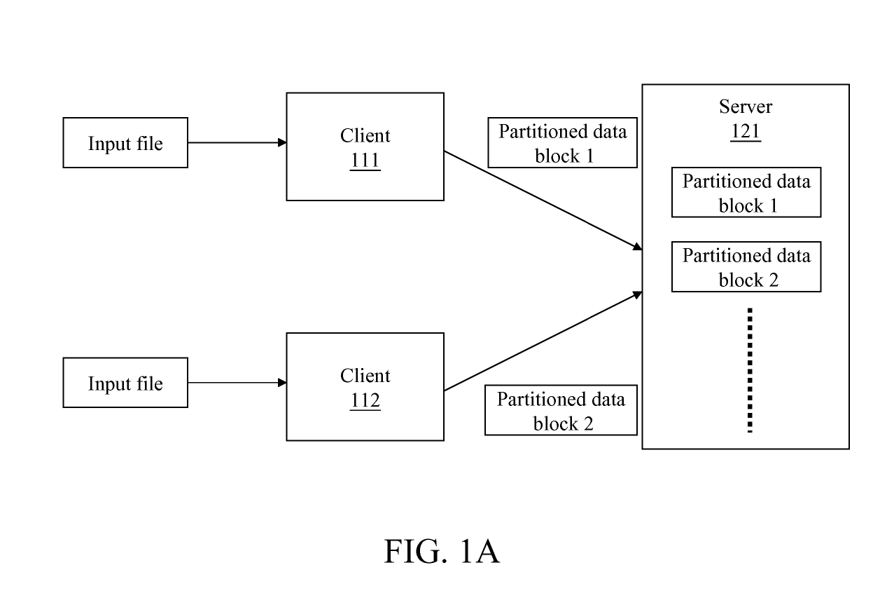

FIG. 1B is a schematic diagram illustrating that different clients have the same key and the same crypto procedure in the prior art;

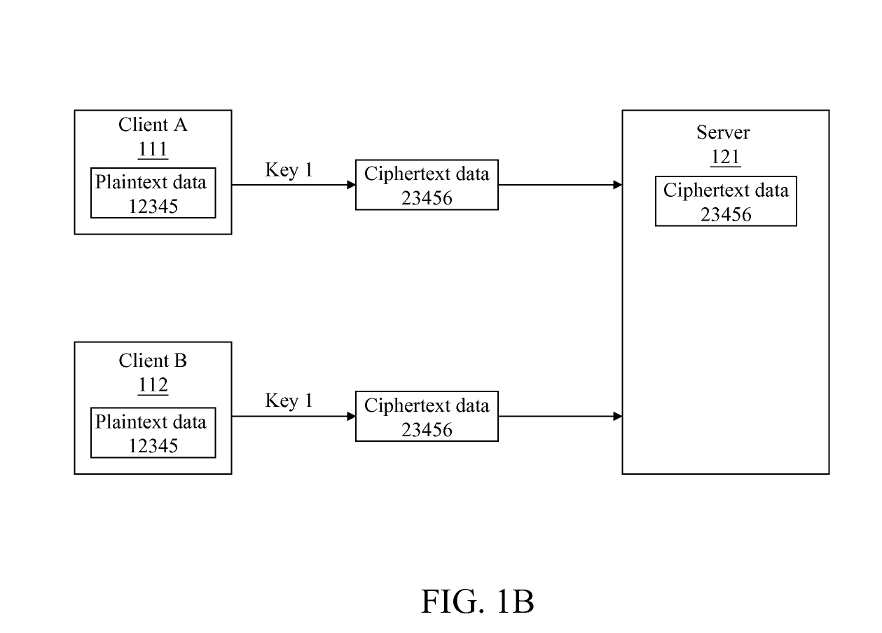

FIG. 1C is a schematic diagram illustrating that different clients have different keys and crypto procedures in the prior art;

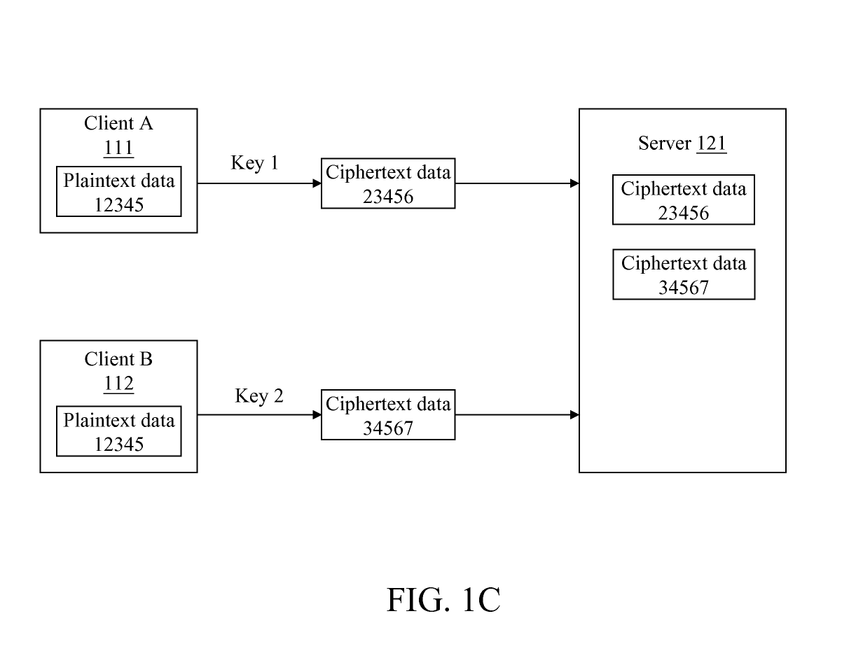

FIG. 2 is a schematic architecture diagram of the present invention, in which a system according to the present invention comprises clients and a server;

FIG. 3 is a schematic flow chart of data de-duplication and crypto performed by a client according to the present invention;

FIG. 4 is a schematic flow chart illustrating that a client reads a partitioned data block according to the present invention;

FIG. 5A is an architecture diagram of clients and a server according to the present invention;

FIG. 5B is a schematic diagram of transmission of ciphertext data generated by a client according to the present invention;

FIG. 5C is a schematic diagram of data transmission according to the present invention; and

FIG. 5D is a schematic diagram of retrieving a partitioned data block according to the present invention.

### DETAILED DESCRIPTION OF THE INVENTION

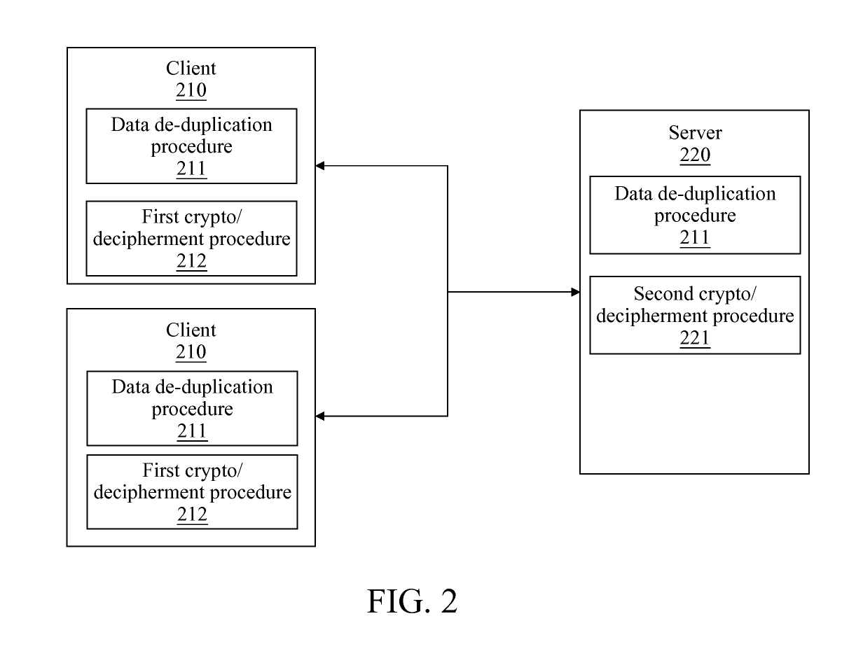

FIG. 2 is a schematic architecture diagram of the present invention. Referring to FIG. 2, a system according to the present invention comprises clients 210 and a server 220. The clients 210 may be connected to the server 220 through Internet or an intranet, or the clients 210 and the server 220 may also run on the same computer device. A data de-duplication procedure 211 and a first crypto/decipherment procedure 212 are performed on the client 210, and a second crypto/decipherment procedure 221 is performed on the server 220. The client 210 performs a data partitioning process in the data de-duplication procedure 211 on an input file. The first crypto/decipherment procedure 212 and the second crypto/decipherment procedure 221 may be, but not limited to, Rivest, Shamir and Adleman (RSA), data encryption standard (DES), triple DES (3DES), international data encryption algorithm (IDEA), advanced encryption standard (AES) or Rivest code (RC).

In the process of data de-duplication, the client 210 performs the partitioning process on the input file. After the input file is partitioned, a plurality of partitioned data blocks is generated. Then, the client 210 performs a corresponding crypto process on the partitioned data block and transports an enciphered result to the server 220 to recognize whether the data block is duplicated data.

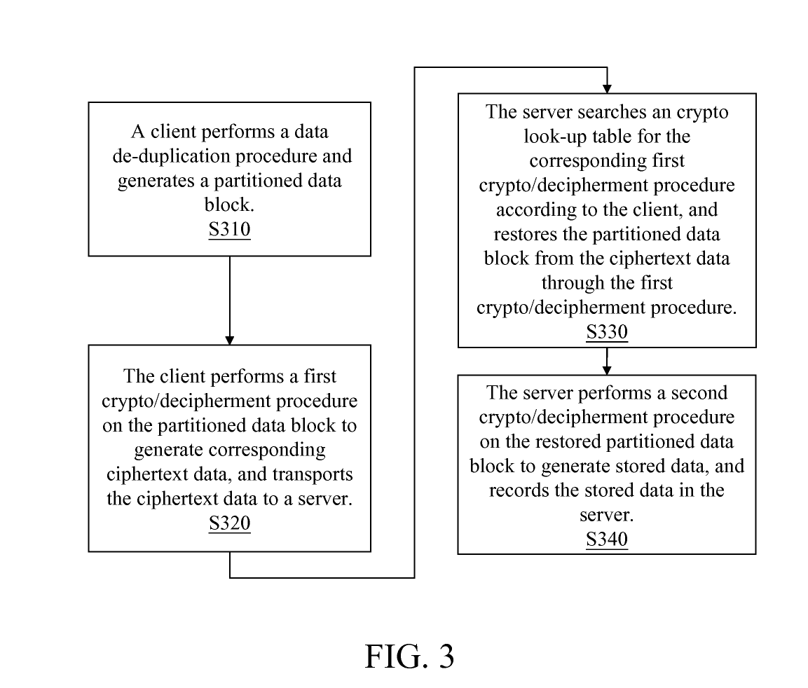

FIG. 3 is a schematic flow chart of data de-duplication and crypto performed by a client according to the present invention. The process in which the client enciphers and transports a partitioned data block according to the present invention comprises the following steps.

In Step S310, the client performs a data de-duplication procedure and generates the partitioned data block.

In Step S320, the client performs a first crypto/decipherment procedure on the partitioned data block to generate corresponding ciphertext data, and transports the ciphertext data to a server.

In Step S330, the server searches an crypto look-up table for the corresponding first crypto/decipherment procedure according to the client, and restores the partitioned data block from the ciphertext data through the first crypto/decipherment procedure.

In Step S340, the server performs a second crypto/decipherment procedure on the restored partitioned data block to generate stored data, and records the stored data in the server.

First, the client 210 performs a partitioning process on an input file, and generates a plurality of groups of partitioned data blocks and hash values each corresponding to each block. An algorithm for calculating the hash value may be, such as, secure hash algorithm (SHA)-1 or message digest algorithm 5 (MD5). A partitioning algorithm for the partitioned data block can be implemented through fixed size partition or content defined chunking (CDC).

After generating the partitioned data block, the client 210 performs an crypto process on the partitioned data block through the first crypto/decipherment procedure 212. The enciphered partitioned data block is defined as the ciphertext data. The keys of the clients 210 are different, so the clients 210 obtain the ciphertext data having different pieces of contents from the same partitioned data block. Then, the client 210 transports the ciphertext data to the server 220.

After receiving the ciphertext data, the server 220 searches the crypto look-up table for the corresponding first crypto/decipherment procedure 212 according to the client 210. An RSA crypto algorithm is taken as an example. It is assumed that the client 210 enciphers the partitioned data block through a public key of the server 220 to generate the corresponding ciphertext data. At the same time, the client 210 signs a private key of the client 210 in a part of partitioned data block (data capable of certificating a source of the client 210) to generate corresponding certification data.

When receiving the ciphertext data having the certification data, the server 220 performs a decipherment process on the ciphertext data according to the held private key. Then, the server 220 obtains a complete partitioned data block. The server 220 performs a decipherment process on the certification data according to a public key of the client 210 to obtain a plaintext of the certification data. If the client 210 signs the private key in the part of partitioned data block, the server 220 may compare whether the received partitioned data blocks are identical, so as to determine whether a transported identity (ID) of the client 210 is correct.

After deciphering the ciphertext data, the server 220 may determine whether contents of the partitioned data block already exist. If the partitioned data block already exists in the server 220, the server 220 may discard the partitioned data block and return a message to the client 210.

For the security of the server 220, the server 220 performs the second crypto/decipherment procedure 221 on the partitioned data block and generates the corresponding stored data. The second crypto/decipherment procedure 221 can be implemented through an asymmetric crypto algorithm or a symmetric crypto algorithm. In this way, the server 220 completes crypto and storage of the partitioned data block.

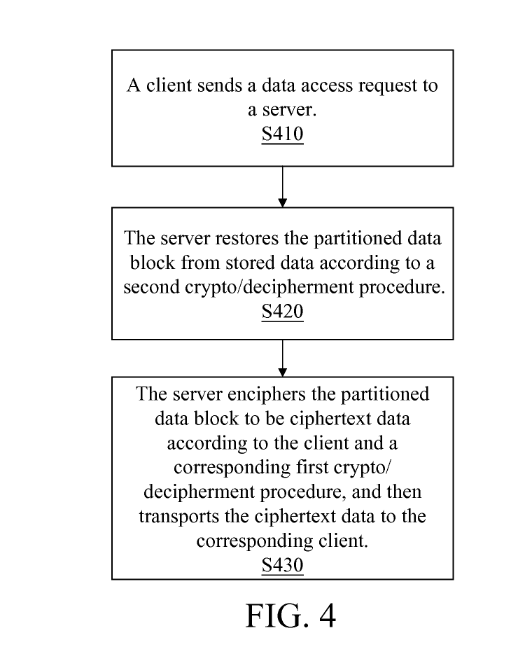

In addition to the crypto and storage of the partitioned data block, the process for the client 210 to access data from the server 220 is also described. FIG. 4 is a schematic flow chart illustrating that a client 210 reads a partitioned data block according to the present invention. Referring to FIG. 4, the process in which client 210 reads the partitioned data block according to the present invention further comprises the following steps.

In Step S410, the client sends a data access request to a server.

In Step S420, the server restores the partitioned data block from stored data according to a second crypto/decipherment procedure.

In Step S430, the server enciphers the partitioned data block to be ciphertext data according to the client and a corresponding first crypto/decipherment procedure, and then transports the ciphertext data to the corresponding client.

First, the client 210 sends the data access request to the server 220 to obtain the partitioned data block to be restored. The server 220 deciphers the stored data through the second crypto/decipherment procedure 221, so that the partitioned data block is restored from the stored data. Finally, the server 220 searches an crypto look-up table according to the client 210 to obtain a first crypto/decipherment procedure 212 used by the client 210. The server 220 enciphers the partitioned data block through the first crypto/decipherment procedure 212 to generate the corresponding ciphertext data. Finally, the server 220 transports the ciphertext data to the corresponding client 210.

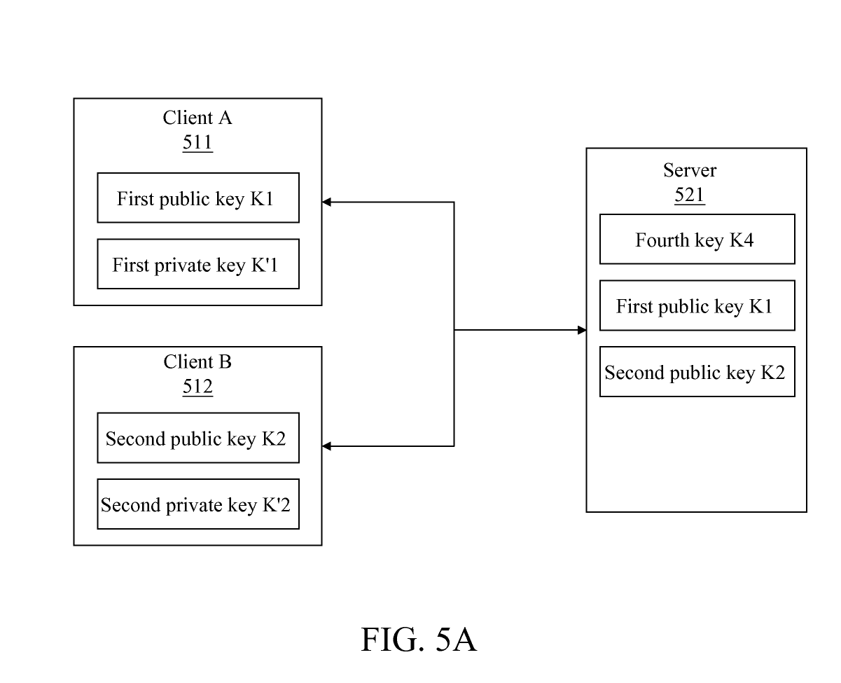

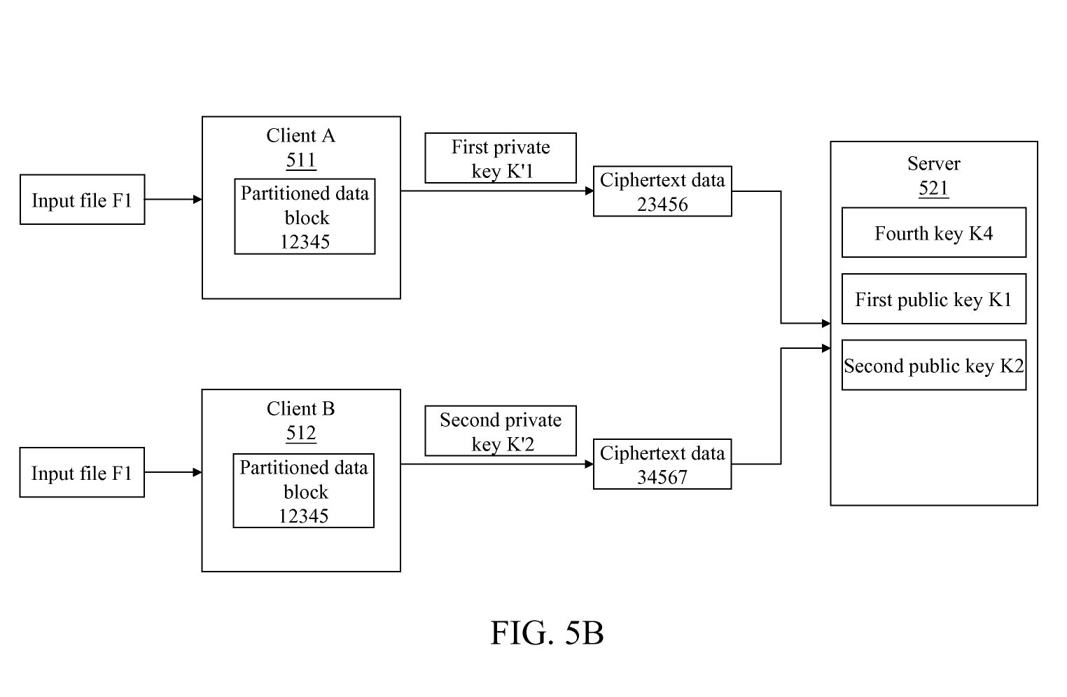

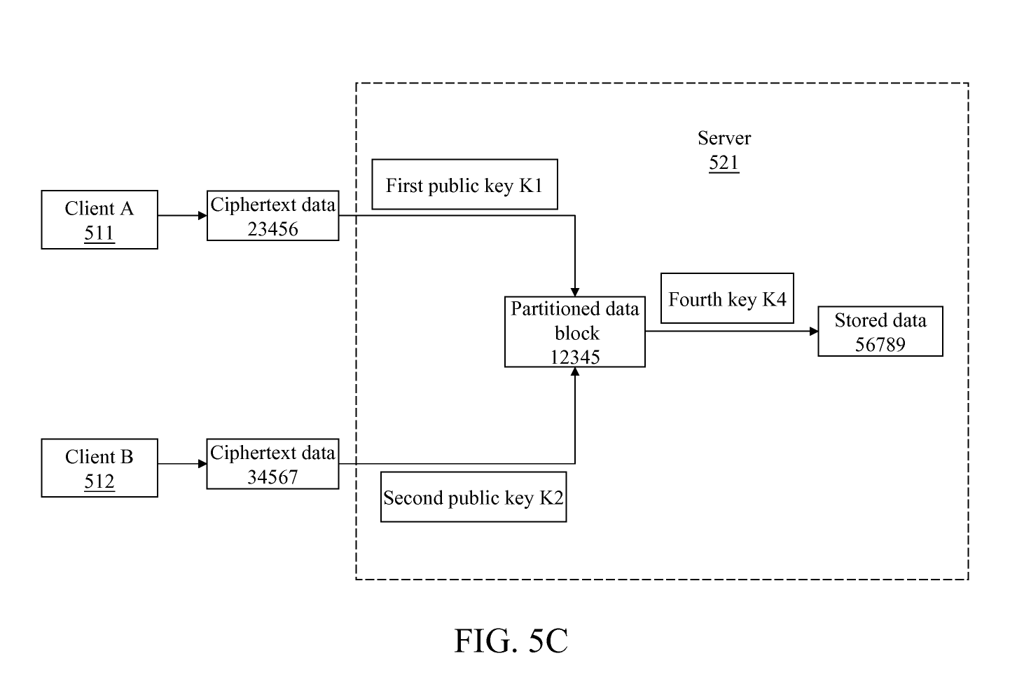

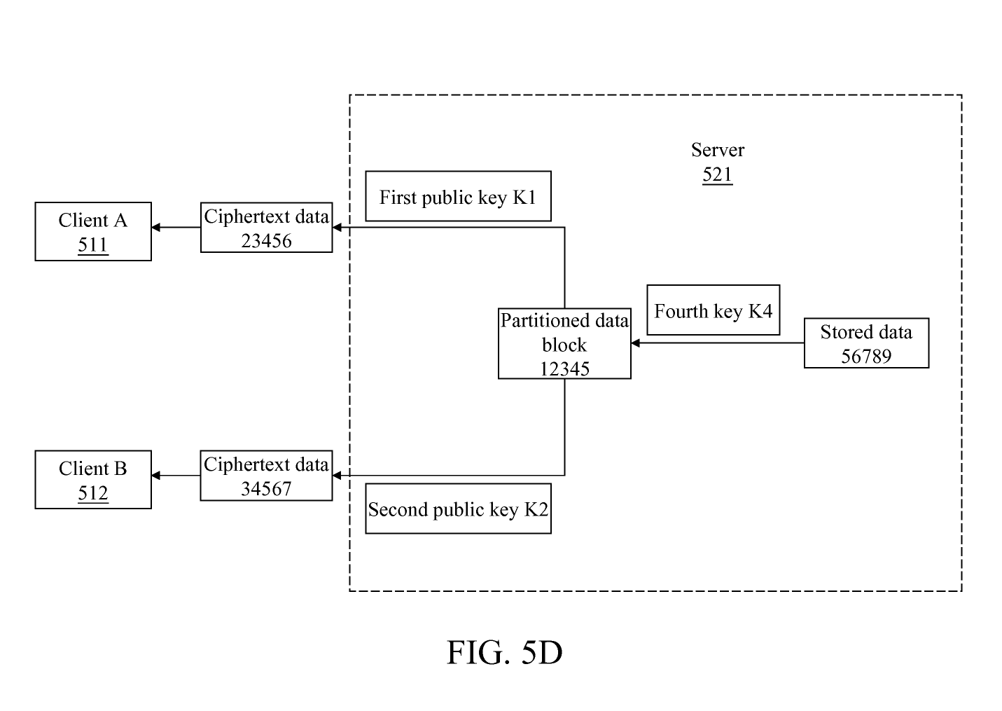

In order to clearly illustrate an operation flow of the present invention, processes, such as crypto, transportation and read, of the plurality of clients are described, but the number of the clients 210, plaintext contents and the crypto algorithm are not limited thereto. It is assumed that one server 521 and two clients (a client A511 and a client B512) exist in the same LAN. The client A511 has a first public key K1 and a first private key K′1, and the client B512 has a second public key K2 and a second private key K′2. In addition to a fourth key K4, the server 521 has the first public key K1 and the second public key K2. FIG. 5A is an architecture diagram of clients and a server 521 according to the present invention.

Referring to FIG. 5A, first, the client A511 obtains an input file F1 and performs a partitioning process on the input file F1 to generate a plurality of groups of partitioned data blocks. The client A511 performs an crypto process on the partitioned data blocks (plaintext contents thereof are “12345”) sequentially through the first private key K′1, and generates ciphertext data (contents thereof are “23456”).

At the same time, the client B512 also obtains the input file F1 and performs the partitioning process on the input file F1 to generate the plurality of groups of partitioned data blocks in the same way. The client performs an crypto process on the partitioned data blocks (the plaintext contents thereof are “12345”) according to the second first private key K′2, and generates ciphertext data (contents thereof are “34567”). FIG. 5B is a schematic diagram of transmission of ciphertext data generated by a client according to the present invention. Referring to FIG. 5B, it can be known that, when the crypto processes for different clients (that is, the crypto processes using different keys) are performed on the same input file F1, different pieces of ciphertext data are generated.

Then, the client A511 and the client B512 transport the ciphertext data to the server 521 respectively. After receiving the ciphertext data, the server 521 performs a first crypto/decipherment procedure 212 on the ciphertext data “23456” and the ciphertext data “34567” respectively. The server may also determine that the ciphertext data “23456” and the ciphertext data “34567” are the same according to restored partitioned data blocks, so the server 521 re-searches for whether the partitioned data blocks are stored. If the partitioned data blocks already exist in the server 521, the server 521 reports a message that the partitioned data blocks already exist to the client A511 and the client B512. FIG. 5C is a schematic diagram of data transmission according to the present invention.

Referring to FIG. 5C, if the server 521 does not store the partitioned data blocks, the server 521 responds to one of the clients and reports that the partitioned data blocks are already stored in the server 521. Then, the server 521 performs a second crypto/decipherment procedure 221 on the restored partitioned data blocks (contents thereof are “12345”) and generates corresponding storage data (contents thereof are “56789”).

When the client B512 intends to obtain the partitioned data blocks (contents thereof are “12345”) from the server 521, the client B512 sends a data access request to the server 521 and designates the partitioned data blocks to be transmitted (which are the stored data in the server 521).

The server 521 deciphers the stored data through the second crypto/decipherment procedure 221 to restore the partitioned data blocks. The server 521 searches an crypto look-up table for the first crypto/decipherment procedure 212 corresponding to the client B512 (that is, obtains a second public key K2 of the client B512) according to the data access request. The server 521 performs an crypto process on the partitioned data blocks according to the second public key K2. The partitioned data blocks are enciphered according to the second public key K2, so the partitioned data blocks can only be deciphered according to a second private key K′2 of the client B512. Therefore, in the process of transmission, it can be ensured that other clients cannot decipher the enciphered ciphertext data. FIG. 5D is a schematic diagram of retrieving a partitioned data block according to the present invention.

Through the data crypto method for the data de-duplication and the system thereof according to the present invention, each client can perform the crypto process on the partitioned data block in a respective crypto manner. Therefore, according to the present invention, the enciphered ciphertext data can be transported to the server 521 in a public network environment. When the client intends to restore data, the client can send a data demanding request to the server 521. The server 521 deciphers the stored data and performs the corresponding crypto process according to the different clients. Therefore, the purpose of secure communication of transmission between the server 521 and the client can be achieved.

What is claimed is:

1. A data crypto method for data de-duplication, for confirming a partitioned data block generated by a client and storing the partitioned data block in a server, the data crypto method comprising:
the client performing a data de-duplication procedure and generating the partitioned data block;
the client performing a first crypto/decipherment procedure on the partitioned data block to generate corresponding ciphertext data and transporting the ciphertext data to the server;
the server searching an crypto look-up table for the corresponding first crypto/decipherment procedure according to the client, and restoring the partitioned data block from the ciphertext data through the first crypto/decipherment procedure; and
the server performing a second crypto/decipherment procedure on the restored partitioned data block to generate stored data, and recording the stored data in the server.

2. The data crypto method for the data de-duplication according to claim 1, wherein the first crypto/decipherment procedure is Rivest, Shamir and Adleman (RSA), data encryption standard (DES), triple DES (3DES), international data encryption algorithm (IDEA), advanced encryption standard (AES) or Rivest code (RC), and the second crypto/decipherment procedure is RSA, DES, 3DES, IDEA, AES or RC.

3. The data crypto method for the data de-duplication according to claim 1, wherein after the server records the stored data, the method further comprises:
the server restoring the partitioned data block from the stored data according to the second crypto/decipherment procedure; and
the server enciphering the partitioned data block to be the ciphertext data according to the client and the corresponding first crypto/decipherment procedure and then transporting the ciphertext data to the corresponding client.

4. A data crypto system for data de-duplication, for confirming a partitioned data block generated by a client and storing the partitioned data block in a server, the data crypto system comprising:
a plurality of clients, each performing a first crypto/decipherment procedure on the partitioned data block to generate corresponding ciphertext data; and
a server, storing an crypto look-up table and a second crypto/decipherment procedure, wherein the crypto look-up table is used to record the first crypto/decipherment procedure of each client, the server receiving the ciphertext data transported by the clients, searching the crypto look-up table for the corresponding first crypto/decipherment procedure according to the client and restoring the partitioned data block from the ciphertext data through the first crypto/decipherment procedure, and performing the second crypto/decipherment procedure on the restored partitioned data block to generate stored data.

5. The data crypto system for the data de-duplication according to claim 4, wherein the first crypto/decipherment procedure is Rivest, Shamir and Adleman (RSA), data encryption standard (DES), triple DES (3DES), international data encryption algorithm (IDEA), advanced encryption standard (AES) or Rivest code (RC), and the second crypto/decipherment procedure is RSA, DES, 3DES, IDEA, AES or RC.

6. The data crypto system for the data de-duplication according to claim 4, wherein the server restores the partitioned data block from the stored data according to the second crypto/decipherment procedure, the server enciphers the partitioned data block to be the ciphertext data according to the client and the corresponding first crypto/decipherment procedure, and then transports the ciphertext data to the corresponding client.
